(19) United States
(12) Patent Application Publication
(10) Pub. No.: US 2025/0150960 A1
(43) Pub. Date: May 8, 2025

(54) PRE-ASSOCIATIVE QUALITY-OF-EXPERIENCE ADVERTISING

(71) Applicant: Cisco Technology, Inc., San Jose, CA (US)

(72) Inventors: Al Dumdei, San Jose, CA (US); Malcolm M. Smith, Richardson, TX (US); Venkat Chirreddy, San Jose, CA (US); Brian D. Hart, Sunnyvale, CA (US)

(73) Assignee: Cisco Technology, Inc., San Jose, CA (US)

(21) Appl. No.: 18/937,844

(22) Filed: Nov. 5, 2024

Related U.S. Application Data
(60) Provisional application No. 63/596,296, filed on Nov. 5, 2023.

(51) Int. Cl. H04W 48/20; H04L 41/5067; H04W 24/10

(52) U.S. Cl. CPC H04W 48/20; H04L 41/5067; H04W 24/10

(57) ABSTRACT

Sending Quality-of-Experience (QoE) information to clients for selecting an Access Point (AP) may be provided. Sending QoE information can include determining values for a plurality of QoE attributes. Based on the values for the plurality of QoE attributes, a QoE indicator is determined. The QoE indicator is sent to a client, wherein the client is operable to use the QoE indicator to select an Access Point (AP) to connect to.

### RELATED APPLICATION

Under provisions of 35 U.S.C. § 119 (e), Applicant claims the benefit of and priority to U.S. Provisional Application No. 63/596,296, filed Nov. 5, 2023, the disclosure of which is incorporated herein by reference in its entirety.

### TECHNICAL FIELD

The present disclosure relates generally to providing Quality-of-Experience (QoE) information to clients for selecting an Access Point (AP).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Quality of Experience (QoE) information to clients in accordance with aspects of the present disclosure.

FIG. 2 is a block diagram of a Reduced Neighbor Report (RNR) with a QoE indicator in accordance with aspects of the present disclosure.

FIG. 3 is a signal diagram of a signal process for exchanging a QoE report in accordance with aspects of the present disclosure.

FIG. 4 is a block diagram of a QoE report request and response frame in accordance with aspects of the present disclosure.

FIG. 5 is a block diagram of an available QoE attribute request frame in accordance with aspects of the present disclosure.

FIG. 6 is a block diagram of an available QoE attribute response frame in accordance with aspects of the present disclosure.

FIG. 7 is a flow chart of a method for providing a QoE indicator and QoE report to a client in accordance with aspects of the present disclosure.

FIG. 8 is a flow chart of a method for providing QoE information to a client in accordance with aspects of the present disclosure.

FIG. 9 is a block diagram of a computing device in accordance with aspects of the present disclosure.

FIG. 10 is a block diagram of a computing device in accordance with aspects of the present disclosure.

### DETAILED DESCRIPTION

### Overview

Sending Quality-of-Experience (QoE) information to clients for selecting an Access Point (AP) may be provided. Sending QoE information can include determining values for a plurality of QoE attributes. Based on the values for the plurality of QoE attributes, a QoE indicator is determined. The QoE indicator is sent to a client, wherein the client is operable to use the QoE indicator to select an Access Point (AP) to connect to.

Sending QoE information to clients can further include receiving a QoE report request from the client, the QoE report request comprising one or more specified QoE attributes. A QoE report is created comprising the one or more specified QoE attributes. The QoE report is sent to the client, wherein the client is operable to use the QoE report to select the AP to connect to.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Quality-of-Experience (QoE) each AP can provide to a particular client can vary based on multiple factors, including location, AP system characteristics, capacity, the number of associated clients, traffic types being managed, band steering capabilities, the presence of interference, and the like. When a client decides to join a network (e.g., as identified by a Service Set Identifier (SSID)) or roam to another Access Point (AP), there may be little or no information available to the client to select which AP to associate with, such as the AP that can provide the best QoE. Outside of Quality Basic Service Set (QBSS) information and basic load information for example, there may be no predictor or information indicating the QoE the client will have when associating with available APs. Thus, a client may associate with an AP with a lower QoE than another candidate AP without the ability to identify which AP can provide better QoE.

Existing QoE attributes available to clients may be limited to predetermined threshold of a single Key Performance Indicator (KPI) such as latency. The existing transmissions for sending the attributes may also be long (e.g., fourteen bytes), substantially contributing to capacity bloat of communications when the QoE attributes are sent (e.g., beacons, Fast Initial Link Setup (FILS), etc.). This increased congestion can become significant when QoE attributes are broadcast repeatedly and/or unnecessarily sent to clients not using the QoE attributes. Furthermore, when roaming across or otherwise changing bands, there may not be any information available to clients indicating QoE for candidate APs. Clients may also need to associate with an AP before receiving QoE information in certain cases because communications with unassociated clients can be limited, for example to particular types of transmissions.

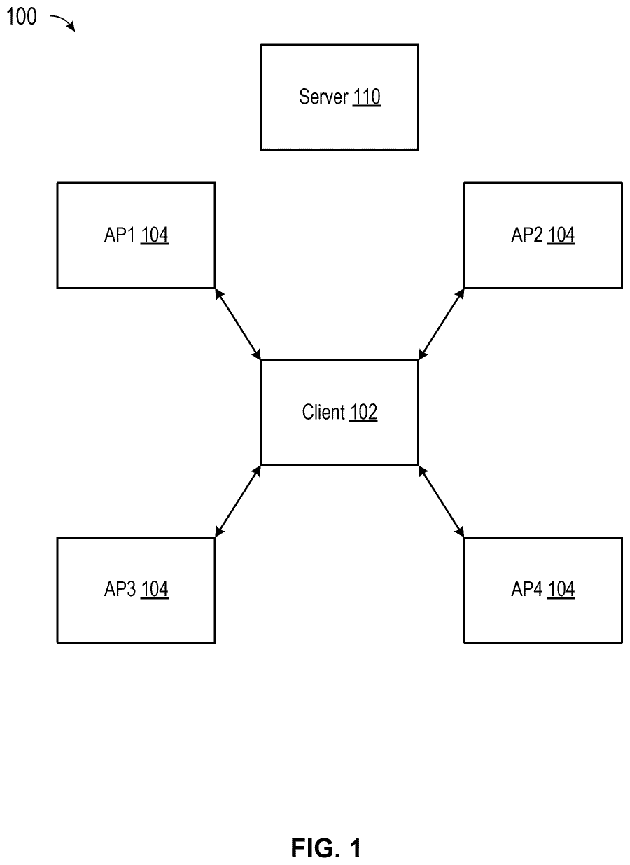

FIG. 1 is a block diagram of an operating environment 100 for providing QoE information to clients. The operating environment 100 includes a client 102, APs 104 (e.g., AP1, AP2, AP3, AP4), and a server 110. The client 102 can be any device that connects to the wireless network via the APs 104, such as a smart phone, a tablet, a personal computer, a server, an Internet-of-Things device, and the like. The APs 104 can enable devices to access the network, such as by creating a Wireless Local Area Network (WLAN). The server 110 may be a device or system that provides resources, data, or services to other devices, such as the client 102 and the APs 104, over the network. The server 110 can be a physical machine, a virtual machine, and/or software.

There may be a different number of devices in the operating environment 100 in further embodiments, including clients 102, APs 104, servers 110, and/or the like.

The client 102 may be in range of, and therefore able to associate with, the APs 104 (i.e., AP1, AP2, AP3, AP4). To ensure proper operation, the client 102 will associate with the AP 104 that can provide the best or otherwise sufficient QoE. However, the client 102 requires information indicating the QoE the APs 104 can provide to select which AP 104 to associate with. Thus, one or more of the APs 104 can send QoE information to the client 102, before or after the client 102 has associated with an AP 104. In certain embodiments, the QoE information comprises a QoE indicator determined from various attributes such as latency, jitter, buffer depth, channel utilization, Central Processing Unit (CPU) utilization, and/or the like. The QoE information can alternatively or additionally comprise a QoE report with a list of QoE KPIs for available APs 104.

The QoE indicator may be a single byte either added as an option field in existing frames or sent via a new QoE frame. For example, the AP 104 can include the QoE indicator in an existing frame, such as a beacon, a probe response, a FILS transmission, an Unsolicited Probe Response (UPR), a Reduced Neighbor Report (RNR), and/or the like. The new QoE frame can be a frame defined by the Institute of Electrical and Electronics Engineers (IEEE) or be a vendor specific frame (e.g., an Enhanced Encapsulating Security Payload (EESP) Information Element (IE)). Each AP 104 may send its associated QoE indicator(s) to the client 102.

In certain embodiments, the QoE indicator is a value, such as on scale of one to two-hundred and fifty-six for a QoE indicator the size of single byte, that provides an overall assessment of the QoE an AP 104 can provide to the client 102. For example, a value of one may indicate that the associated AP 104 will provide the worst possible QoE, a value of two-hundred and fifty-six may indicate that the associated AP 102 will provide the best possible QoE, and the values in between may indicate raising levels of QoE provided as the value increases in example implementations. Thus, the client 102 may determine to associate with the AP 104 with the highest value QoE indicator since the highest QoE may be provided by that AP 104.

As described above, the value of the QoE indicator can be determined based on one or more QoE attributes or KPIs of the associated AP 104, such as latency, jitter, packet loss, buffer depth, channel utilization, CPU utilization, and/or the like. Each QoE attribute can be a value set based on how the attribute will affect QoE. For example, the latency attribute may be a low value when there is high latency and a high value when there is low latency. The lower the latency attribute value is, the lower the QoE indicator will therefore be, thereby indicating that QoE may be affected by high latency. The QoE attributes can also be assigned weights to make more important or otherwise preferred attributes affect the QoE indicator value more than less important or otherwise unpreferred attributes (e.g., latency may have a strong affect on QoE and be assigned a high weight, CPU utilization may marginally affect QoE or not affect QoE and therefore be assigned a low weight).

Weights can be set by a network vendor based on operating expectations. For example, one vendor may normally have devices operate at a high memory or CPU usage level and set the CPU utilization attribute a low or zero weight because the high CPU usage level is not seen as an indicator of poor device performance. Another vendor may consider CPU usage levels as an indicator of poor performance and assign a higher weight to correspondingly indicate the impacted performance in the QoE indicators. This flexibility allows different vendors and devices to identify what is important for their infrastructure.

An individual AP 104 may determine QoE indicators for itself, or the server 110 and/or other devices may determine the QoE indicators for the APs 104. To determine the QoE indicators, the server 110 and/or other devices can monitor the operation of the APs 104, receive QoE attribute information from the APs 104, the client 102, and/or other devices, and/or the like. The server 110 can then determine the QoE indicators for each AP 104 using the QoE attribute information. In some example implementations, the server 110 can compare the QoE attribute information of the APs 104 to determine which APs 104 have better values compared to the other APs 104 when determining the QoE indicators.

Each QoE indicator can be determined for a particular channel in example implementations, so an AP 104 may have multiple associated QoE indicators if the AP 104 supports multiple channels. Additionally, because the QoE indicators can be sent to the client 102 before association or via any connection to an AP 104 (e.g., in a RNR), the client 102 can use the QoE indicators to determine information about multiple channels without having to go off channel. In some embodiments, the QoE indicators can be included in Radio Resource Measurement action frames (e.g., as described by IEEE 802.11k neighbor reports and other neighbor discovery mechanisms, as described by IEEE 802.11r fast roaming mechanisms), Wireless Network Management action frames (e.g., as described by IEEE 802.11v), and/or the like the like. The action frames can be used to assist clients, such as the client 102, in selecting APs 104 to roam to or otherwise associate with.

In certain embodiments, the APs 104, the server 110, and/or the like can use machine learning techniques to determine the QoE indicator values, including determining QoE attributes, weights assigned to the attributes, etc. The machine learning techniques can also be used to determine QoE reports and/or other methods and operations as described herein. In general, machine learning is concerned with the design and the development of techniques that take data (e.g., network statistics, performance indicators) as input, and recognize complex patterns in the data. One common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used to classify new data points. Often, M is a statistical model, and the cost function is inversely proportional to the likelihood of M, given the input data.

In various implementations, the APs 104, the server 110, and/or the like may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. Unsupervised techniques do not require a training set of labels. While a supervised learning model may look for previously seen patterns that have been labeled as such, an unsupervised model may instead look to whether there are sudden changes or patterns in the behavior of the attributes. Semi-supervised learning models are a mixed approach that use a reduced set of labeled training data.

Example machine learning techniques that the APs 104, the server 110 and/or other devices can employ may include Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the APs 104, the server 110, and/or the like may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

The QoE report may be shared using the Generic Advertisement Service (GAS) and, specifically, the Access Network Query Protocol (ANQP). By using ANQP, the client 102 can receive QoE reports without associating with an AP 104. When the client 102 desires or otherwise determines to receive additional QoE information instead of or in addition to the QoE indicator, for example to gain a better understanding of the performance beyond the indicator, the client 102 may send a QoE report request to an AP 104. In embodiments, the QoE report request and the QoE report returned in response to the request are both be carried in a standard GAS frame. The QoE report request can be a standard ANQP message, a vendor specific ANQP message, or the like.

The QoE report request can include a request for one or more KPIs or QoE attributes. The APs 104 can advertise which QoE attributes available for inclusion in a QoE report, and the client 102 can select one or more of the available QoE attributes to request in the QoE report request. Each QoE attribute may also have a long or short option the client 102 can request based on the level of information desired. The short option for a QoE attribute may include less information but be a smaller size to limit the size of the report for transmission and analysis, while long option for a QoE attribute may include additional information but have a larger size. The QoE request can also specify the bands the client 102 wants QoE information for. Thus, the client 102 can determine the QoE attributes and therefore the provided QoE of all bands the APs 104 have available without having to change channels. The QoE request can also specify QoE attribute periods for QoE attribute data collection (e.g., the past ten seconds, the past thirty seconds, the past ten seconds and next ten seconds, etc.).

The APs 104 can exchange information to determine the QoE report, or the server 110 can collect information from the APs 104, generate the QoE report, and send the report to an AP 104 for transmission to the client. The QoE report includes a list of the requested KPIs or QoE attributes and one or more threshold options for the KPIs. The QoE report enables the client 102 to determine the performance of the APs 104 without having to authenticate and associate with one of the APs 104. Additionally, since sending the QoE report to the client 102 is unicast and only in response to the client 102 sending the QoE report request, the QoE report process does not result in excessive usage of network resources (e.g., Radio Frequency (RF) pollution) like adding the QoE report into a beacon, a probe response, a FILS transmission, a UPR transmission, or the like would add.

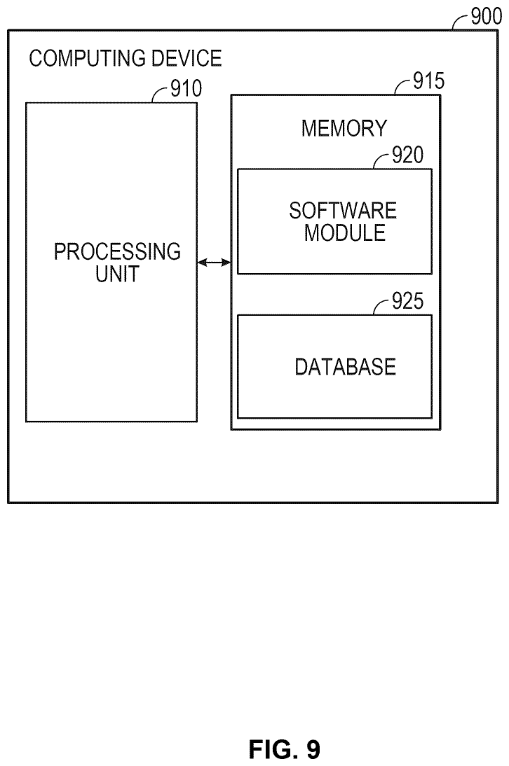

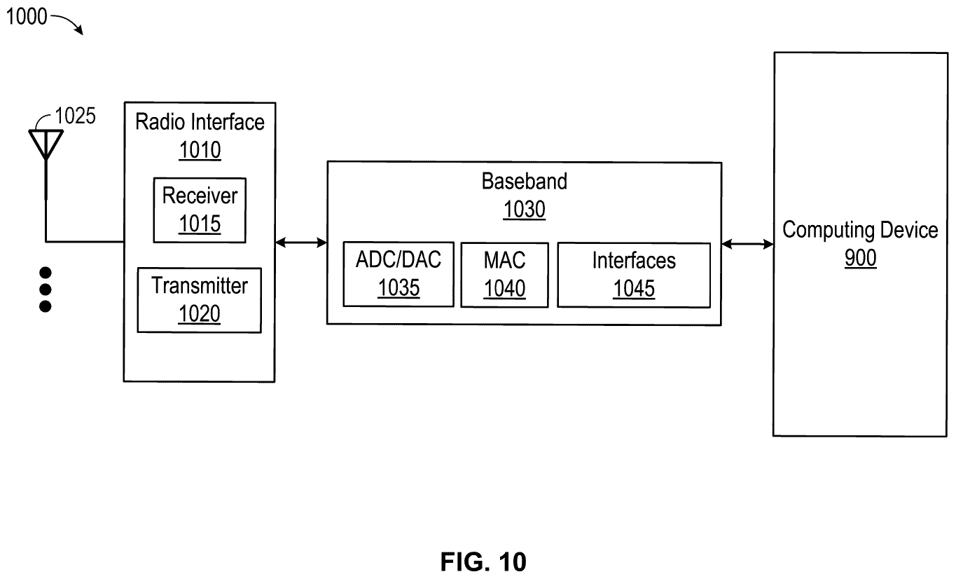

The elements described above of the operating environment 100 (e.g., the client 102, the APs 104, the server 110, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 9 and 10, the elements of the operating environment 100 may be practiced in a computing device 900 and/or communications device 1000.

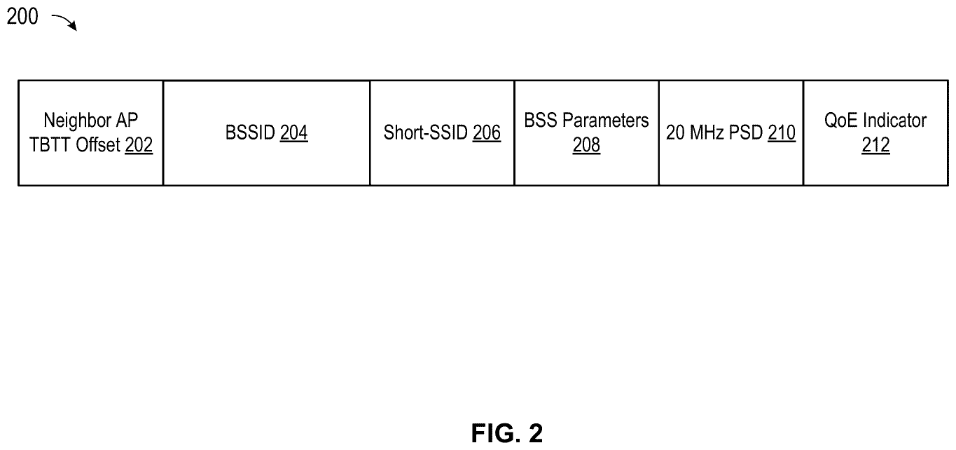

FIG. 2 is a block diagram of a RNR 200 with a QoE indicator. An AP 104 or other device can send a QoE indicator to the client 102 in a beacon, in a FILS transmission, in a UPR transmission, and/or in the RNR 200. The RNR 200 includes a neighbor AP Target Beacon Transmission Time (TBTT) field 202, a Basic Service Set Identifier (BSSID) field 204, a short-Service Set Identifier (short-SSID) field 206, a Basic Service Set (BSS) parameters field 208, a Power Spectral Density (PSD) field 210, and a QoE indicator field 212. The neighbor AP TBTT field 202 may define the interval beacons with the RNR 200 are transmitted. The BSSID field 204 may comprise the BSSID of the AP 104 transmitting the RNR 200. The short-SSID field 206 may comprise the SSIDs of available bands (e.g., 6 Gigahertz band) of the AP 104, the BSS parameters field 208 may comprise BSS parameters such as co-located APs, whether unsolicited probe responses are active, and the like. The PSD field 210 may comprise the maximum power transmit for the primary channel.

The QoE indicator field 212 may comprise a QoE indicator. For example, an AP 104 can send the RNR 200 with the QoE indicator indicating its determined QoE to the client 102. In some embodiments, the QoE indicator field 212 is a single byte and only comprises a single QoE indicator. Thus, an AP 104 may send multiple RNRs 200 to send multiple QoE indicators, such as QoE indicators for each available band. In other embodiments, the QoE indicator field 212 may comprise multiple bytes for sending multiple QoE indicators. A beacon, a FILS transmission, a UPR transmission, and/or the like may similarly include a QoE indicator field 212 when used.

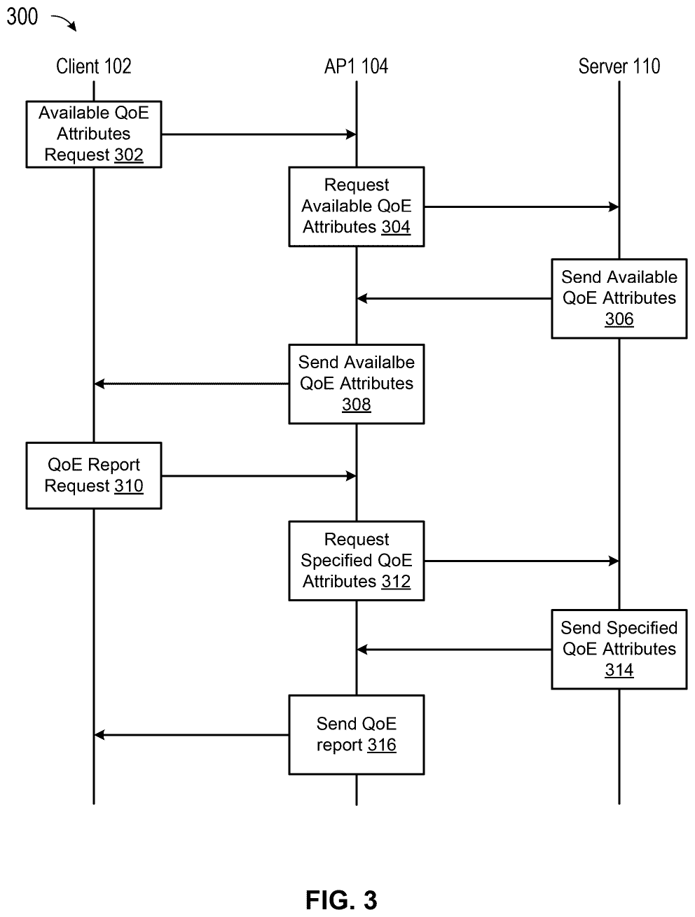

FIG. 3 is a signal diagram of a signal process 300 for exchanging a QoE report. The client 102, AP1 104, and the server 110 communicate in the illustrated embodiment, but other devices such as one or more APs 104 may communicate with the client 102 and server 110 in other embodiments. In certain embodiments, the client 102 may request the identification of available QoE attributes before sending a QoE report request, and the signal process 300 would begin at operation 302. In other embodiments, the client 102 may send a QoE report request without requesting the identification of the available QoE attributes, such as if the client 102 already knows the available QoE attributes or expects the requested QoE attributes to be available. In some example implementations, the client 102 may request multiple QoE attributes to be included in the QoE report without knowing which attributes are available and simply use the QoE attributes that are returned in the QoE report. When the client 102 does not request the identification of the available QoE attributes, the signal process 300 may begin at operation 310.

In operation 302, the client 102 sends an available QoE attributes request to AP1 104. The client 102 sends the available QoE attributes request to request a list of available QoE attributes the APs 104 can include in a QoE report. In operation 304, AP1 104 forwards the available QoE attributes request or sends a new available QoE attributes request to the server 110. The server 110 responds with an available QoE attributes response including a list of available QoE attributes in operation 306. In some embodiments, the APs 104 may know the available QoE attributes without communicating with the server 110, and operation 304 and operation 306 may be skipped. In operation 308, AP1 104 sends an available QoE attributes response including a list of available QoE attributes, either by forwarding the QoE attributes response from the server 110 or sending a new QoE attributes response.

The client 102 can select one or more available QoE attributes to receive information on and, in operation 310, the client 102 can send a QoE report request requesting the information for the selected QoE attributes. In operation 312, AP1 104 can send a specified QoE attributes request to the server 110 to request the selected QoE attributes for the APs 104. In some embodiments, the specified attributes request is the QoE report request received from the client 102 or a new QoE report request. In operation 314, the server 110 can respond with a specified QoE attributes response comprising the selected QoE attributes for the APs 104. In some embodiments, the specified QoE attributes response is a QoE report. In other embodiments, the AP 104 creates the QoE report using the specified QoE attributes response. For example, the AP1 104 may determine its own selected QoE attributes and create the QoE report using its own attributes and the specified QoE attributes response. In operation 316, AP1 104 sends a QoE report comprising the selected QoE attributes for the APs 104. The client 102 can then evaluate the QoE report to select an AP 104 to associate with that will provide the best or otherwise sufficient QoE according to the evaluation.

In embodiments, the available QoE attributes requests, the available QoE attributes responses, the QoE report request, the specified QoE attributes request, the specified QoE attributes response, and the QoE report a standard ANQP message, a vendor specific ANQP message, or the like. For example, the QoE attributes requests, the QoE report request, and the specified QoE attributes request are ANQP requests, and the available QoE attributes responses, the specified QoE attributes response, and the QoE report are ANQP responses. The available QoE attributes requests, the available QoE attributes responses, the QoE report request, the specified QoE attributes request, the specified QoE attributes response, and the QoE report can be carried in a standard GAS frame. Thus, the client 102 can participate in the signal process 300 without being associated with the AP 104.

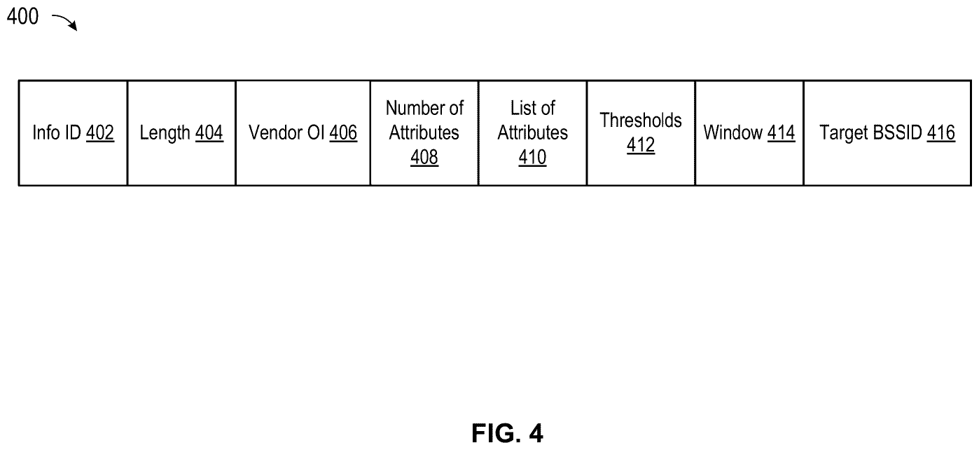

FIG. 4 is a block diagram of a QoE report request and response frame 400. The client 102 can use the QoE request and response frame 400 to send a QoE report request, such as in operation 310. The APs 104 can use the QoE request and response frame 400 to send a specified QoE attributes request (e.g., a QoE report request) to the server 110, such as in operation 312. The server 110 can use the QoE request and response frame 400 to send a specified QoE attributes response to an AP 104 (e.g., operation 314). The APs 104 can also use the QoE request and response frame 400 to send a QoE report to the client 102, such as in operation 316.

The QoE request and response frame 400 can include an information identifier field 402, a length field 404, a vendor Optional Information (OI) field 406, a number of attributes field 408, a list of attributes field 410, a thresholds field 412, a window field 414, and a target BSSID field 416. The information identifier field 402 can comprise network information such as an SSID, the channel in use, a Traffic Indication Map, supported rates, etc. The length field 404 specifies the length of the QoE request and response frame 400, such as the data section of the QoE request and response frame 400. The vendor OI field 406 can comprise optional information for the QoE attributes.

The number of attributes field 408 indicates the number of QoE attributes requested when the QoE request and response frame 400 is a request and indicates the number of QoE attributes included when the QoE request and response frame 400 is a response. The list of attributes field 410 comprises a list of the requested QoE attributes when the QoE request and response frame 400 is a request and comprises a list of included QoE attributes when the QoE request and response frame 400 is a response. The thresholds field 412 indicates a request for a short option or long option for the QoE attributes when the QoE request and response frame 400 is a request and indicates the supplied option for the QoE attributes when the QoE request and response frame 400 is a response. The window field 414 may indicate the requested period for determining QoE attributes when the QoE request and response frame 400 and indicated the used period for determining QoE attributes when the QoE request and response frame 400 is a response. The target BSSID field 416 may indicate the target BSSID of the request or response.

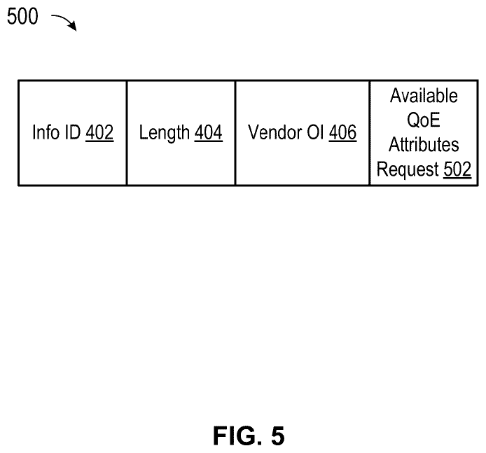

FIG. 5 is a block diagram of an available QoE attribute request frame 500. The client 102 can use the available QoE attribute request frame 500 to send an available QoE attributes request to an AP 104, such as in operation 302. The APs 104 can use the available QoE attribute request frame 500 to send an available QoE attributes request to the server 110, such as in operation 304.

The available QoE attribute request frame 500 includes an information identifier field 402, a length field 404, a vendor OI field 406, and an available QoE attributes request field 502. The available QoE attributes request field 502 can be set to indicate that a list of available QoE attributes is requested.

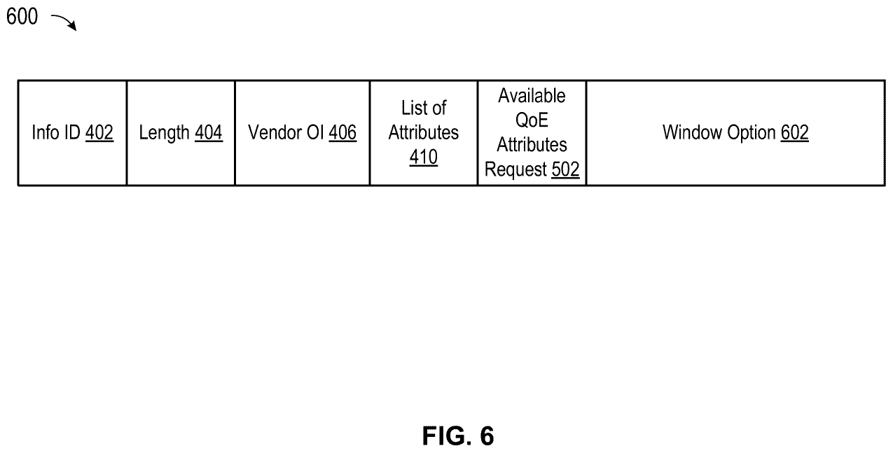

FIG. 6 is a block diagram of an available QoE attribute response frame 600. The server 110 can use the available QoE attribute response frame 600 to send the available QoE attributes to an AP 104, such as in operation 306. The APs 104 can use the available QoE attribute response frame 600 to send the available QoE attributes to the client 102, such as in operation 308.

The available QoE attribute response frame 600 comprises an information identifier field 402, a length field 404, a vendor OI field 406, a list of attributes field 410, an available QoE attributes request field 502, and a window option field 602. The list of attributes field 410 can comprise a list of the available QoE attributes. The available QoE attributes request field 502 can be set to indicate that the list of available QoE attributes is being delivered. The window option field 602 can include proposed periods the client 102 can select to receive QoE attributes.

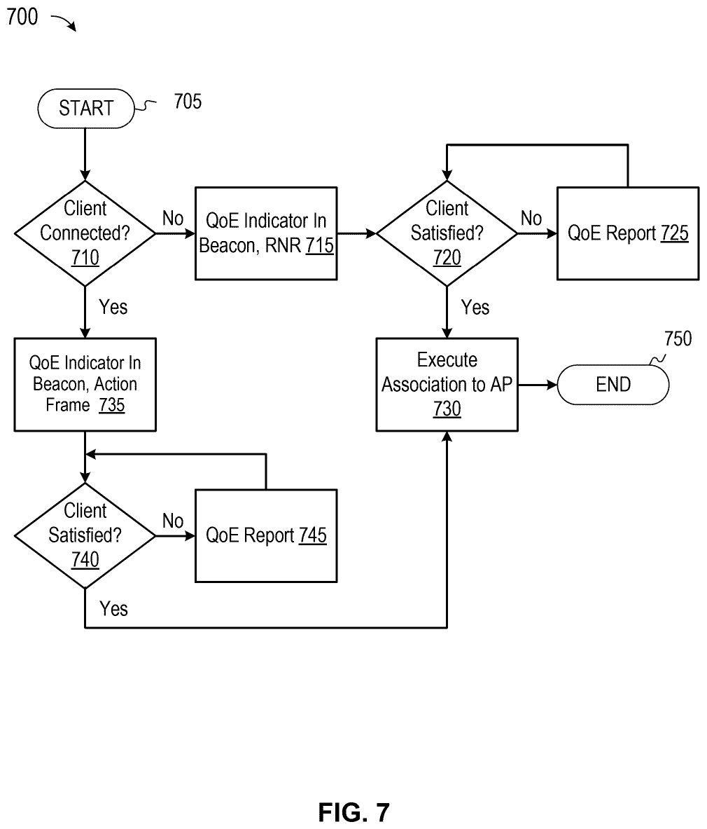

FIG. 7 is a flow chart of a method 700 for providing a QoE indicator and QoE report to a client. The method 700 may begin at starting block 705 and proceed to decision 710. In decision 710, it is determined whether the client 102 is connected to an AP 104. If the client 102 is not connected (e.g., associated) to an AP 104, the method 700 proceeds to operation 715. In operation 715, a QoE indicator is sent. For example, one or more of the APs 104 send one or more QoE indicators, such as a QoE indicator for each band the respective AP 104 supports. The APs 104 may send the QoE indicators in a beacon, a RNR (e.g., the RNR 200 illustrated in FIG. 2), and/or some other transmission that can be completed without the client associating with the APs 104.

In decision 720, it is determined whether the client 102 is satisfied with the QoE indicators. If the client 102 is not satisfied, the client 102 may send a QoE report request to one or more of the APs 104. Then, in operation 725, an AP 104 can send the requested QoE report to the client 102. The AP 104 can send the QoE report using ANQP so the client 102 does not have to associate with the AP 104. The method 700 can proceed back to decision 720, and if the client 102 is still not satisfied, the client 102 can request another QoE report with different QoE attributes. If the client 102 is satisfied in decision 720, the method 700 proceeds to operation 730, and the client 102 and a selected AP 104 connect via an association process.

If the client 102 is connected to an AP 104 in decision 710, the method 700 proceeds to operation 735. In operation 735, the AP 104 can send one or more QoE indicators in a beacon, an action frame (e.g., as described in 802.11k, 802.11r, 802.11v), and/or the like because the AP 104 is not limited to transmissions that can be sent when the client 102 is not associated. Other APs 104 can send their QoE indicators to the connected AP 104 or send the QoE indicators to the client 102 directly via beacons, the RNR 200, and/or the like.

In decision 740, it is determined whether the client 102 is satisfied with the QoE indicators. If the client 102 is not satisfied, the client 102 may send a QoE report request to the connected AP 104. Then, in operation 745, the AP 104 can send the requested QoE report to the client 102. The method 700 can proceed back to decision 740, and if the client 102 is still not satisfied, the client 102 can request another QoE report with different QoE attributes. If the client 102 is satisfied in decision 740, the method 700 proceeds to operation 730, and the client 102 and a selected AP 104 connect. The method 700 can conclude at ending block 750.

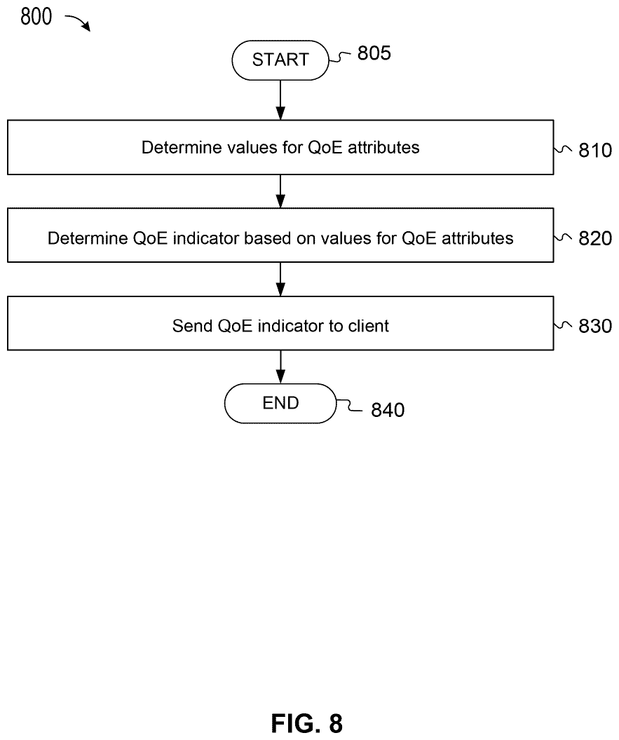

FIG. 8 is a flow chart of a method 800 for providing QoE information to a client. The method 800 may be performed between a client (e.g., the client 102) and an AP (e.g., one or more of the APs 104) without the client needed to be associated with the AP. The method 800 may begin at starting block 805 and proceed to operation 810. In operation 810, values for a plurality of QoE attributes are determined. For example, an AP 104 determines values for latency, jitter, buffer depth, channel utilization, CPU utilization, and/or the like.

In operation 820, a QoE indicator is determined based on the values for the plurality of QoE attributes. For example, the AP 104 determines the QoE indicator based on the values determined in operation 810. The method 800 can comprise assigning weights to the plurality of QoE attributes, wherein determining the QoE indicator is further based on the weights. In operation 830, the QoE indicator is sent to a client. For example, the AP 104 sends the QoE indicator to the client 102, and the client 102 is operable to use the QoE indicator to select an AP 104 to connect to. Sending the QoE indicator to the client 102 can comprise sending the QoE indicator in a beacon, a probe response, an action frame, a RNR 200, a UPR, a FILS transmission, and/or the like.

The method 800 can further comprise the AP 104 receiving a QoE report request from the client 102, the QoE report request comprising one or more specified QoE attributes. The QoE report request can comprises a request for a long option or a short option for each of the one or more specified QoE attributes, a selection of bands for QoE information, one or more periods to determine the one or more specified QoE attributes, and/or the like. The QoE report request can be an ANQP message. The AP 104 can create a QoE report comprising the one or more specified QoE attributes, such as according to the operations described above (e.g., operation 312, operation 314). The AP 104 can send the QoE report to the client 102, wherein the client 102 is operable to use the QoE report to select the AP 104 to connect to. Sending the QoE report to the client 102 can comprise sending an ANQP message comprising the QoE report.

The method 800 can also comprise receiving an available QoE attributes request from the client 102. The AP 104 can determine one or more available QoE attributes, such as according to the operations described above (e.g., operation 304, operation 306. The AP 104 can send an available QoE attributes response to the client 102 (e.g., operation 308), wherein the client 102 is operable to select the one or more specified QoE attributes from the one or more available QoE attributes. The method 800 may conclude at ending block 840.

FIG. 9 is a block diagram of a computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for sending QoE information to clients for selecting an AP to connect to with respect to FIGS. 1-8. Computing device 900, for example, may provide an operating environment for the client 102, the APs 104, the server 110, and the like. The client 102, the APs 104, the server 110, and the like may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 900 on the single integrated circuit (chip).

FIG. 10 illustrates an implementation of a communications device 1000 that may implement one or more of the client 102, the APs 104, the server 110, etc., of FIGS. 1-8. In various implementations, the communications device 1000 may comprise a logic circuit. The logic circuit may include physical circuits to perform operations described for one or more of the client 102, the APs 104, the server 110, etc., of FIGS. 1-8, for example. As shown in FIG. 10, the communications device 1000 may include one or more of, but is not limited to, a radio interface 1010, baseband circuitry 1030, and/or the computing device 900.

The communications device 1000 may implement some or all of the structures and/or operations for the client 102, the APs 104, the server 110, etc., of FIGS. 1-8, storage medium, and logic circuit in a single computing entity, such as entirely within a single device. Alternatively, the communications device 1000 may distribute portions of the structure and/or operations using a distributed system architecture, such as a client station server architecture, a peer-to-peer architecture, a master-slave architecture, etc.

A radio interface 1010, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1010 may include, for example, a receiver 1015 and/or a transmitter 1020. The radio interface 1010 may include bias controls, a crystal oscillator, and/or one or more antennas 1025. In additional or alternative configurations, the radio interface 1010 may use oscillators and/or one or more filters, as desired.

The baseband circuitry 1030 may communicate with the radio interface 1010 to process, receive, and/or transmit signals and may include, for example, an Analog-To-Digital Converter (ADC) for down converting received signals with a Digital-To-Analog Converter (DAC) 1035 for up converting signals for transmission. Further, the baseband circuitry 1030 may include a baseband or PHYsical layer (PHY) processing circuit for the PHY link layer processing of respective receive/transmit signals. Baseband circuitry 1030 may include, for example, a Media Access Control (MAC) processing circuit 1040 for MAC/data link layer processing. Baseband circuitry 1030 may include a memory controller for communicating with MAC processing circuit 1040 and/or a computing device 900, for example, via one or more interfaces 1045.

In some configurations, PHY processing circuit may include a frame construction and/or detection module, in combination with additional circuitry such as a buffer memory, to construct and/or deconstruct communication frames. Alternatively or in addition, MAC processing circuit 1040 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining values for a plurality of Quality of Experience (QoE) attributes;
determining a QoE indicator based on the values for the plurality of QoE attributes; and
sending the QoE indicator to a client, wherein the client is operable to use the QoE indicator to select an Access Point (AP) to connect to.

2. The method of claim 1, further comprising:
receiving a QoE report request from the client, the QoE report request comprising one or more specified QoE attributes;
creating a QoE report comprising the one or more specified QoE attributes; and
sending the QoE report to the client, wherein the client is operable to use the QoE report to select the AP to connect to.

3. The method of claim 2, wherein the QoE report request comprises any one of (i) a request for a long option or a short option for each of the one or more specified QoE attributes, (ii) a selection of bands for QoE information, (iii) one or more periods to determine the one or more specified QoE attributes, or (iv) any combination of (i)-(iii).

4. The method of claim 2, wherein:
the QoE report request is an Access Network Query Protocol (ANQP) message; and
sending the QoE report to the client comprises sending a second ANQP message comprising the QoE report.

5. The method of claim 2, further comprising:
receiving an available QoE attributes request from the client;
determining one or more available QoE attributes; and
sending an available QoE attributes response to the client, wherein the client is operable to select the one or more specified QoE attributes from the one or more available QoE attributes.

6. The method of claim 1, further comprising assigning weights to the plurality of QoE attributes, wherein determining the QoE indicator is further based on the weights.

7. The method of claim 1, wherein sending the QoE indicator to the client comprises sending the QoE indicator in any one of (i) a beacon, (ii) a probe response, (iii) an action frame, (iv) a Reduced Neighbor Report (RNR), (v) an Unsolicited Probe Response (UPR), (vi) a Fast Initial Link Setup (FILS) transmission, or (vii) any combination of (i)-(vi).

8. A system comprising:
a memory storage; and
a processing unit coupled to the memory storage, wherein the processing unit is operative to:
determine values for a plurality of Quality of Experience (QoE) attributes;
determine a QoE indicator based on the values for the plurality of QoE attributes; and
send the QoE indicator to a client, wherein the client is operable to use the QoE indicator to select an Access Point (AP) to connect to.

9. The system of claim 8, the processing unit being further operative to:
receive a QoE report request from the client, the QoE report request comprising one or more specified QoE attributes;
create a QoE report comprising the one or more specified QoE attributes; and
send the QoE report to the client, wherein the client is operable to use the QoE report to select the AP to connect to.

10. The system of claim 9, wherein the QoE report request comprises any one of (i) a request for a long option or a short option for each of the one or more specified QoE attributes, (ii) a selection of bands for QoE information, (iii) one or more periods to determine the one or more specified QoE attributes, or (iv) any combination of (i)-(iii).

11. The system of claim 9, wherein:
the QoE report request is an Access Network Query Protocol (ANQP) message; and
to send the QoE report to the client comprises to send a second ANQP message comprising the QoE report.

12. The system of claim 9, the processing unit being further operative to:
receive an available QoE attributes request from the client;
determine one or more available QoE attributes; and
send an available QoE attributes response to the client, wherein the client is operable to select the one or more specified QoE attributes from the one or more available QoE attributes.

13. The system of claim 8, the processing unit being further operative to assign weights to the plurality of QoE attributes, wherein to determine the QoE indicator is further based on the weights.

14. The system of claim 8, wherein to send the QoE indicator to the client comprises to send the QoE indicator in any one of (i) a beacon, (ii) a probe response, (iii) an action frame, (iv) a Reduced Neighbor Report (RNR), (v) an Unsolicited Probe Response (UPR), (vi) a Fast Initial Link Setup (FILS) transmission, or (vii) any combination of (i)-(vi).

15. A non-transitory computer-readable medium that stores a set of instructions which when executed perform a method executed by the set of instructions comprising:
determining values for a plurality of Quality of Experience (QoE) attributes;
determining a QoE indicator based on the values for the plurality of QoE attributes; and
sending the QoE indicator to a client, wherein the client is operable to use the QoE indicator to select an Access Point (AP) to connect to.

16. The non-transitory computer-readable medium of claim 15, the method executed by the set of instructions further comprising:
receiving a QoE report request from the client, the QoE report request comprising one or more specified QoE attributes;
creating a QoE report comprising the one or more specified QoE attributes; and
sending the QoE report to the client, wherein the client is operable to use the QoE report to select the AP to connect to.

17. The non-transitory computer-readable medium of claim 16, wherein the QoE report request comprises any one of (i) a request for a long option or a short option for each of the one or more specified QoE attributes, (ii) a selection of bands for QoE information, (iii) one or more periods to determine the one or more specified QoE attributes, or (iv) any combination of (i)-(iii).

18. The non-transitory computer-readable medium of claim 16, wherein:
the QoE report request is an Access Network Query Protocol (ANQP) message; and
sending the QoE report to the client comprises sending a second ANQP message comprising the QoE report.

19. The non-transitory computer-readable medium of claim 17, the method executed by the set of instructions further comprising:
receiving an available QoE attributes request from the client;
determining one or more available QoE attributes; and
sending an available QoE attributes response to the client, wherein the client is operable to select the one or more specified QoE attributes from the one or more available QoE attributes.

20. The non-transitory computer-readable medium of claim 15, the method executed by the set of instructions further comprising assigning weights to the plurality of QoE attributes, wherein determining the QoE indicator is further based on the weights.
